(19) United States
(12) Patent Application Publication
(10) Pub. No.: US 2014/0116589 A1
(43) Pub. Date: May 1, 2014

(54) Pneumatic Tire

(71) Applicant: COOPER TIRE & RUBBER COMPANY, Findlay, OH (US)

(72) Inventors: Christopher D. Grote, Findlay, OH (US); Jeremy J. Jacobs, Findlay, OH (US)

(73) Assignee: Cooper Tire & Rubber Company, Findlay, OH (US)

(21) Appl. No.: 13/661,798

(22) Filed: Oct. 26, 2012

(51) Int. Cl. B60C 11/04

(52) U.S. Cl. CPC B60C 11/04
USPC 152/209.21

(57) ABSTRACT

This pneumatic tire has a plurality of lateral grooves, wherein each of the lateral grooves has a first side wall, a second side wall, a bottom surface and a groove width. A plurality of protrusions extending from the first side wall towards the second side wall; and a plurality of protrusions extending from the second side wall towards the first side wall. The protrusions are configured to prevent the lateral grooves from fully closing in the contact patch during rotation of the tire through the contact patch.

### TECHNICAL FIELD

The invention relates to pneumatic tires having protrusions in the lateral grooves.

### BACKGROUND OF THE INVENTION

A common belief in the tire industry is that a “stiffer” tire performs better in the area of handling. A common practice in the tire industry is to use tie bars to increase the stiffness of the tread blocks that extend across the grooves and slots between adjacent tread blocks. These tie bars are molded into the tire tread and have a height usually less than the depth of the tread blocks so that a top surface of the tie bar is below the surface of the tread block and only come into contact with the road as the tire wears.

Another practice in the tire industry to prevent stones from being trapped or held in the grooves, is to include a plurality of protrusions arranged at intervals along the bottom of a groove.

Based on the theory that a “stiffer” tire performs better in the area of rolling resistance we have developed protrusions to effectively help stiffen the tires.

### SUMMARY OF THE INVENTION

The present invention provides a pneumatic tire having a tread area having a plurality of circumferential grooves and a plurality of lateral grooves, wherein each of the lateral grooves has a first side wall, a second side wall, a bottom surface and a groove width; a plurality of protrusions extending from the first side wall towards the second side wall; and a plurality of protrusions extending from the second side wall towards the first side wall; wherein the protrusions are configured to prevent the plurality of lateral grooves from fully closing during rotation of the tire.

In a preferred embodiment, the plurality of protrusions extend between 30% to 95% of the groove width. The protrusions in the sides of the lateral groove walls prevent the side wall from making contact with the opposite groove wall as the tire rotates through the contact patch. This reduces the amount that the lateral grooves can close when they are in the contact patch and effectively help reduce “air pumping” within the lateral grooves. The result in less radiated tire noise in the areas of both pass-by and in-vehicle noise. The protrusions also create a tortuous path for air/sound to travel.

Other objects and advantages of the present invention will become apparent to those skilled in the art upon a review of the following detailed description of the preferred embodiments and the accompanying drawings.

### IN THE DRAWINGS

FIG. 1 is a perspective view of the pneumatic tire in accordance with the invention.

FIG. 2 is a top view showing a first embodiment of the protrusions in side walls of the lateral groove of the pneumatic tire.

FIG. 3 is a top view of a second embodiment.

FIG. 4 is a top view of a third embodiment.

FIG. 5 is a top view of a fourth embodiment.

FIG. 6 is a top view of a fifth embodiment.

FIG. 7 is a side view of a sixth embodiment.

FIG. 8 is a side view of a seventh embodiment.

FIG. 9 is a side view of a eighth embodiment.

FIG. 10 is a side view of an ninth embodiment.

### DETAILED DESCRIPTION OF THE INVENTION

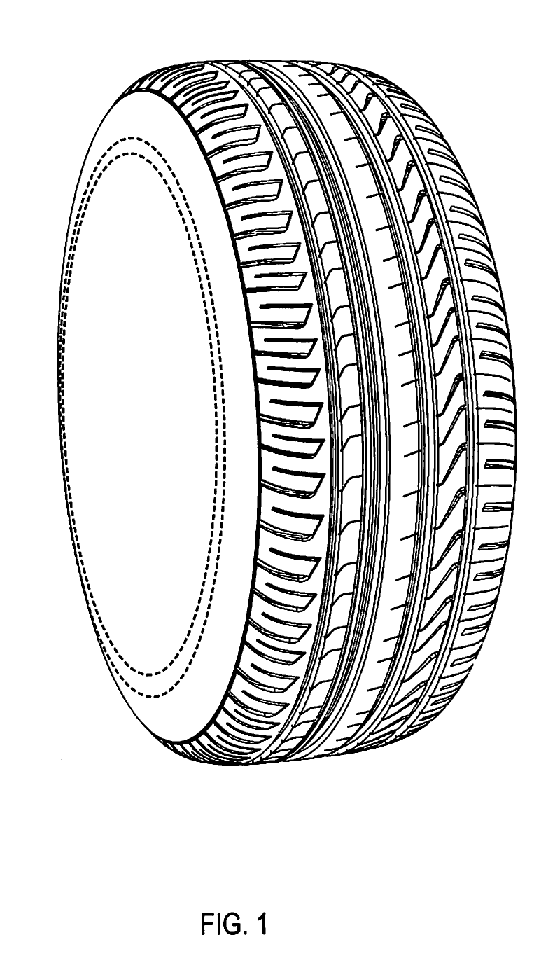

FIG. 1 is a perspective view of the pneumatic tire in accordance with the invention. Pneumatic tires such as used for passenger vehicles and trucks, have a tread pattern which extends circumferentially about the tire. The tread consists of a plurality of circumferentially and laterally extending grooves which divide the tread into generally circumferentially extending ribs formed by a plurality of either continuous or discontinuous tread blocks. The tread blocks may be separated by lateral grooves or slots which provide for expelling water to prevent hydroplaning and provide better traction in snow and mud. However, these slots and/or grooves provide increased flexibility to the tread blocks which, for certain applications, is less desirable than stiffer tread blocks, we developed protrusions in the side walls of the lateral grooves of the pneumatic tire.

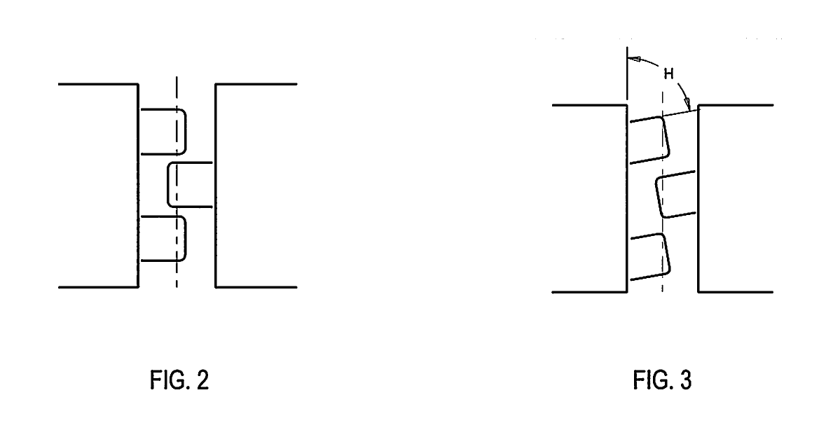

FIG. 2 is a top view showing a first embodiment of the protrusions in side walls of the lateral groove of the pneumatic tire. The protrusions in FIG. 2 have parallel sides.

FIG. 3 is a top view of a second embodiment. The protrusions of FIG. 3 are at an angle H relative to the axis of the lateral groove.

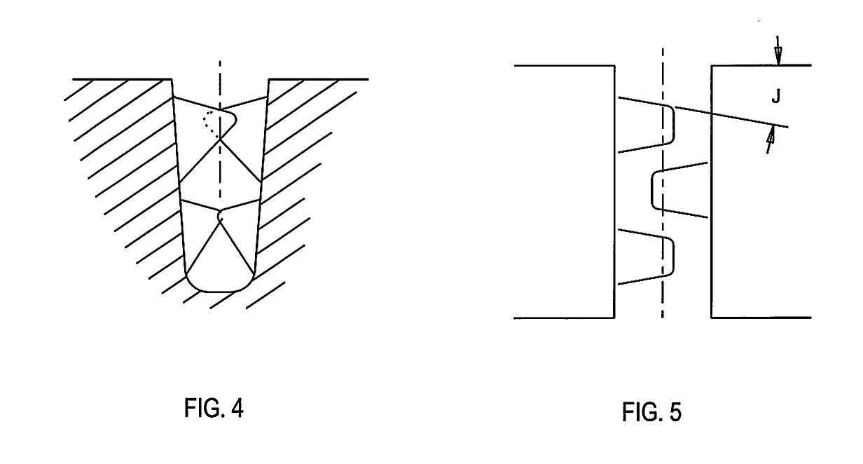

FIG. 4 is a side view of a third embodiment. FIG. 4 shows multiple rows of protrusions.

FIG. 5 is a top view of a fourth embodiment. FIG. 5 shows protrusions that have non-parallel sides tapering down in width at an angle J.

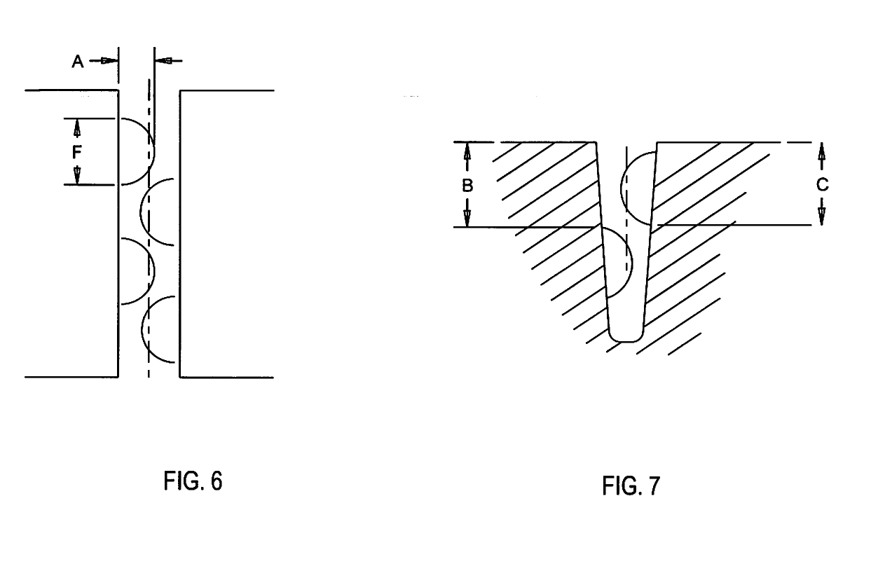

FIG. 6 is a top view of a fifth embodiment. FIG. 6 shows protrusions that have a spherical or elliptical shape.

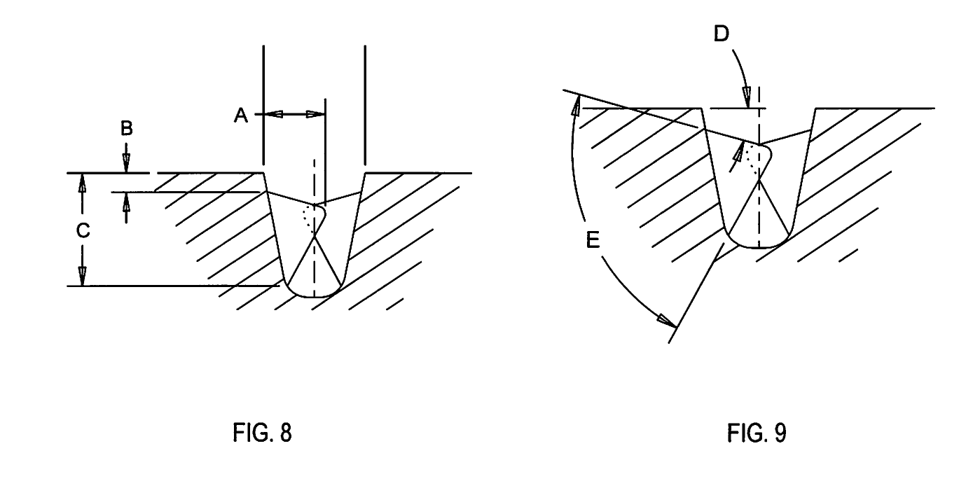

FIG. 7 is a side view of a sixth embodiment. FIG. 7 shows the embodiment where all the protrusions on one side of the groove in one row, and all the protrusions on the other side of the groove in other rows.

FIG. 8 is a side view of a seventh embodiment.

FIG. 9 is a side view of a eighth embodiment.

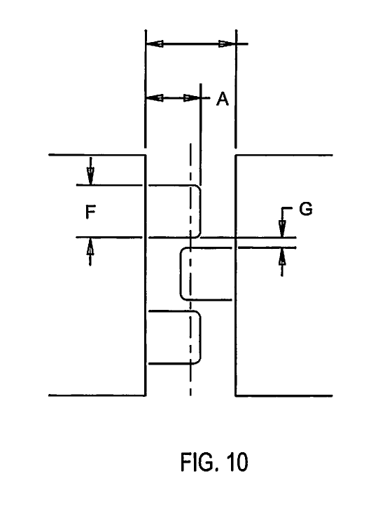

FIG. 10 is a side view of an ninth embodiment.

FIGS. 8-10. show minimum and maximum groove depth and groove width of the protrusions. FIGS. 3, 5 and 9 also show angles for embodiments of this invention.

| | Minimum | Maximum |
|---|---|---|
| Groove Width (GW) | 0.05 | 1.00 |
| Groove Depth (GD) | 0.10 | 1.00 |
| A | 30% of GW | 95% of GW |
| B | 0% of GD | 75% of GD |
| C | 5% of GD | 100% of GD |
| D | 0° | 70° |
| E | 30° | 120° |
| F | 0.05 | 1.00 |
| G | 0.00 | 1.00 |
| H | 45° | 90° |
| J | 0° | 45° |

### INDUSTRIAL APPLICABILITY

1. Handling
a. Based on the theory that a “stiffer” tire performs better in the area of handling, wherever used, this invention effectively helps to stiffen adjacent tread blocks effectively increasing the tires performance in the area of rolling resistance.

2. Noise
a. Reducing the amount that the lateral grooves can close when they are in the contact patch should effectively help to reduce “air pumping” within said lateral grooves, and thus result in less radiated tire noise in the areas of both pass-by and in-vehicle noise. The protrusions also reduce noise by creating a tortuous path for air/sound to travel.

3. Winter (Snow) Performance
a. Reducing the amount that the lateral grooves can close when they are in the contact patch should make it possible to increase the amount of snow that can be taken in by said lateral grooves. An increase in traction and cornering stability on snow should be a direct result.

4. Soft Handling/On-Center Feel
a. By effectively making the adjacent ribs more “solid”, the overall soft handling of the tire, as well as the on-center feel, should increase.

5. Wet Traction
a. By keeping the lateral grooves from fully closing as they rotate through the contact patch, the protrusions provide a benefit for wet traction by maintaining more void volume in the pattern.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. A pneumatic tire comprising:
a tread area having a plurality of circumferential grooves and a plurality of lateral grooves, wherein each of the lateral grooves has a first side wall, a second side wall, a bottom surface and a groove width;
a plurality of protrusions extending from the first side wall towards the second side wall;
a plurality of protrusions extending from the second side wall towards the first side wall;
wherein the protrusions are configured to prevent the plurality of lateral grooves from fully closing during rotation of the tire; and
wherein the protrusions are configured to prevent the side walls from making contact with each other during rotation of the tire.

2. A pneumatic tire according to claim 1 wherein the plurality of protrusions extend between 30-95% of the groove width.

3. A pneumatic tire according to claim 1 wherein the plurality of protrusions extend between 40% to 90% of the groove width.

4. A pneumatic tire according to claim 1 wherein the plurality of protrusions extend between 50% to 80% of the groove width.

5. A pneumatic tire according to claim 1 wherein the plurality of protrusions extend between 60% to 80% of the groove width.

6. A pneumatic tire according to claim 1 wherein the lateral grooves have a geometric centerline and the protrusions are perpendicular to the centerline.

7. A pneumatic tire according to claim 1 wherein the lateral grooves have a geometric centerline and the protrusions are at an angle to the centerline.

8. A pneumatic tire according to claim 1 wherein the protrusions have parallel sides.

9. A pneumatic tire according to claim 1 wherein the protrusions have non-parallel sides.

10. A pneumatic tire according to claim 1 wherein the protrusions have a spherical or elliptical shape.

11. A pneumatic tire according to claim 1 wherein the protrusions have a triangular shape.

12. A pneumatic tire according to claim 1 wherein the protrusions have a square shape.

13. A pneumatic tire according to claim 1 wherein the protrusions have a rectangular shape.

14. A pneumatic tire according to claim 1 wherein at least two rows of protrusions extend from each of the side walls of the lateral grooves.

15. (canceled)

16. A pneumatic tire according to claim 1 wherein the lateral grooves have a groove depth and the protrusions have a height that is less than the groove depth.

17. A pneumatic tire according to claim 1 wherein the lateral grooves have a groove depth and the protrusions have a height that is 5% to 95% of the groove depth.

18. A pneumatic tire according to claim 1 wherein the lateral grooves have a groove depth and the protrusions have a height that is 10% to 90% of the groove depth.

19. A pneumatic tire according to claim 1 wherein the lateral grooves have a groove depth and the protrusions have a height that is 20% to 80% of the groove depth.

20. A pneumatic tire according to claim 1 wherein the lateral grooves have a groove depth and the protrusions have a height that is 5% to 100% of the groove depth.

21. A pneumatic tire comprising:
a tread area having a plurality of circumferential grooves and a plurality of lateral grooves, wherein each of the lateral grooves has a first side wall, a second side wall, a bottom surface and a groove width;
a plurality of protrusions extending only from the first side wall towards the second side wall;
wherein the protrusions are configured to prevent the plurality of lateral grooves from fully closing during rotation of the tire; and
wherein the protrusions are configured to prevent the side walls from making contact with each other during rotation of the tire.
